(19) United States
(12) Patent Application Publication
(10) Pub. No.: US 2026/0074269 A1
(43) Pub. Date: Mar. 12, 2026

(54) PRESSING APPARATUS FOR SECONDARY BATTERY

(71) Applicant: SAMSUNG SDI CO., LTD., Yongin-si (KR)

(72) Inventors: JUNHWA PARK, Yongin-si (KR); BEOMJOO KIM, Yongin-si (KR); SANGMYEONG KIM, Yongin-si (KR); WOONGJIP KANG, Yongin-si (KR); HANYOUNG CHOI, Yongin-si (KR); JIYOUNG HWANG, Yongin-si (KR)

(21) Appl. No.: 19/019,192

(22) Filed: Jan. 13, 2025

(30) Foreign Application Priority Data
Sep. 6, 2024 (KR) 10-2024-0121881

(51) Int. Cl. H01M 10/04

(52) U.S. Cl. CPC H01M 10/0481

(57) ABSTRACT

Provided is a pressing apparatus for a secondary battery for improving the efficiency of a secondary battery manufacturing process and the performance or structural stability of the secondary battery. The pressing apparatus for the secondary battery includes a case part for arranging a plurality of secondary batteries along one direction, an end plate configured to be movable inside the case part in the one direction and apply pressure to the secondary batteries in the one direction, a pulley part connected to one side of the end plate, and a wire part configured to be wound around the pulley part and to transmit power in the one direction to the pulley part to move the end plate along the one direction.

### CROSS-REFERENCE TO RELATED APPLICATION

The present application claims priority to and the benefit of Korean Patent Application No. 10-2024-0121881, filed on Sep. 6, 2024, in the Korean Intellectual Property Office, the disclosure of which is incorporated by reference herein in its entirety.

### BACKGROUND

### 1. Field

One or more embodiments relate to a pressing apparatus for a secondary battery.

### 2. Description of the Related Art

In general, with the rapid development of electrical and/or electronic, communications and computer industries, the demand for high-performance and high-safety secondary batteries has been rapidly increasing. In particular, with the trend toward lighter, thinner, and more portable electrical and electronic products, secondary batteries, which are components of such products, may be required to be lighter and smaller.

In some examples, as environmental pollution problems, such as air pollution and noise, due to the mass proliferation of automobiles and the need for new forms of energy sources due to the depletion of oil have arisen, the need for the development of electric vehicles to solve these problems has increased It is therefore desirable develop batteries with high output and high energy density as the power sources for the vehicles.

In response to such demands, a relatively high-performance, next-generation, high-tech new battery that has been receiving attention recently is a secondary battery. Lithium, used as an anode, has been spotlighted as an electrode material for high energy density batteries because of its relative low density (e.g., very low density) and standard reduction potential.

During manufacturing of the secondary battery, a process of pressing the secondary battery may be required to increase the performance of the secondary battery, such as structural stability or energy density of the secondary battery.

The above-described information disclosed in the background technology of this disclosure is provided to improve understanding of the background of the disclosure and therefore may include information that does not constitute the prior art.

### SUMMARY

One or more embodiments of the present disclosure are directed to a pressing apparatus for a secondary battery for improving the efficiency of a manufacturing process of the secondary batter and the performance or structural stability of the secondary battery.

The problems to be solved by the embodiments of the present disclosure are not limited to the problems mentioned above, and other problems and advantages of the present invention that are not mentioned can be understood by the following description and will be more clearly understood by the embodiments of the disclosure. Further, it will be readily understood that the objects and advantages of the embodiments of the disclosure may be realized by the limitations set forth in the appended claims and combinations thereof.

According to one or more embodiments, a pressing apparatus for a secondary battery includes a case part for arranging a plurality of secondary batteries along one direction, an end plate configured to be movable inside the case part in the one direction, and apply pressure to the secondary batteries in the one direction, a pulley part connected to one side of the end plate, and a wire part configured to be wound around the pulley part, and to transmit power in the one direction to the pulley part to move the end plate along the one direction.

In an embodiment, the pulley part may be rotatably connected to one side of the end plate.

In an embodiment, a rotational center axis of the pulley part may be perpendicular to a center axis of a movement direction of the end plate.

In an embodiment, the pulley part may be connected to a side surface portion of the end plate, and the wire part may extend along the one direction on a side wall portion of the case part which faces the side surface portion of the end plate.

In an embodiment, the end plate may include a first end plate arranged at one end portion of the case part, and a second end plate arranged at a second end portion of the case part opposite to the one end portion, the plurality of secondary batteries may be arranged between the first end plate and the second end plate along the one direction, and the pulley part may include a first pulley connected to the first end plate, and a second pulley connected to the second end plate.

In an embodiment, the wire part may be wound around each of the first pulley and the second pulley, such that the first pulley and the second pulley are connected to each other.

In an embodiment, the pressing apparatus for the secondary battery may further include a winder part fixedly positioned on the one end portion of the case part and configured to wind or unwind the wire part based on power from outside.

In an embodiment, a diameter of the first pulley connected to the first end plate adjacent to the winder part may be smaller than a diameter of the second pulley connected to the second end plate positioned a distance away from the winder part.

In an embodiment, a guide hole extending along the one direction may be formed in the side wall portion of the case part, and the pulley part may be connected to the side surface portion of the end plate through the guide hole.

In an embodiment, the pressing apparatus for the secondary battery may further include a winder part fixedly positioned on the case part and configured to wind or unwind the wire part based on power from outside.

In an embodiment, the end plate may be arranged at one end portion of the case part, and the winder part may be arranged at a second end portion of the case part opposite to the one end portion.

In an embodiment, the wire part may be arranged between the one end portion and the second end portion of the case part and connect the end plate and the winder part to each other.

According to one or more embodiments, a pressing apparatus for a secondary battery includes a case part for arranging a plurality of secondary batteries along one direction, an end plate configured to be movable inside the case part in the one direction and apply pressure to the secondary batteries in the one direction, a pulley part connected to one side of the end plate, and a wire part disposed between opposite end portions of the case part and configured to generate tension in the pulley part.

In an embodiment, the pulley part may be rotatably connected to the end plate.

In an embodiment, the pulley part may be connected to a side surface portion of the end plate, and the wire part may extend along the one direction on a side wall portion of the case part which faces the side surface portion of the end plate.

In an embodiment, the pressing apparatus for the secondary battery may further include a winder part fixedly positioned on the case part and configured to wind or unwind the wire part based on power from outside.

In an embodiment, the end plate may be arranged at one end portion of the case part, and the winder part may be arranged at a second end portion of the case part opposite to the one end portion.

In an embodiment, the wire part may be arranged between the one end portion and the second end portion of the case part and connect the end plate and the winder part to each other.

In an embodiment, the end plate may include a first end plate arranged at one end portion of the case part, and a second end plate arranged at a second end portion of the case part opposite to the one end portion, the plurality of secondary batteries may be arranged between the first end plate and the second end plate along the one direction, and the pulley part may include a first pulley connected to the first end plate, and a second pulley connected to the second end plate.

In an embodiment, a diameter of the first pulley connected to the first end plate adjacent to the winder part may be smaller than a diameter of the second pulley connected to the second end plate positioned a distance away from the winder part.

### BRIEF DESCRIPTION OF THE DRAWINGS

The following drawings attached to this specification illustrate preferred embodiments of the disclosure and, together with the detailed description of the disclosure described below, serve to further understand the technical idea of the disclosure; therefore, the disclosure should not be interpreted as being limited to matters described in such drawings:

FIG. 1 is a schematic perspective view of a pressing apparatus for a secondary battery according to one exemplary embodiment;

FIG. 2 is a side view of the pressing apparatus for the secondary battery illustrated in FIG. 1;

FIG. 3 is a top plan view of the pressing apparatus for the secondary battery illustrated in FIG. 1;

FIG. 4 depicts the pressing apparatus for the secondary battery illustrated in FIG. 1 applying pressing force to a plurality of secondary batteries;

FIG. 5 depicts an end plate and a pulley part according to one exemplary embodiment;

FIG. 6 depicts a usage state of a control part according to one exemplary embodiment;

FIG. 7 depicts another end plate and a pulley part according to one exemplary embodiment; and

FIG. 8 depicts yet another end plate and a pulley part according to one exemplary embodiment.

### DETAILED DESCRIPTION

Hereinafter, one or more embodiments of the disclosure will be described in detail with reference to the attached drawings. The terms or words used in this specification and claims are not to be interpreted as limited to their usual or dictionary meanings, and are to be interpreted as meanings and concepts that conform to or are consistent with the technical idea of the disclosure based on the principle that the inventor may can be his/her own lexicographer to appropriately define the concept of the term in order to explain his or her own invention in the best way. Therefore, the embodiment described in this specification and the configurations illustrated in the drawings are only some of the embodiment of the disclosure and do not represent all of the technical ideas, aspects, and features of the disclosure, and it should be understood that there may be various equivalents and modified examples that can replace or modify the embodiments at the time of filing this application.

Additionally, when used herein, the words “comprise or include” and/or “comprising or including” specify the presence of stated features, numbers, steps, operations, members, elements, and/or groups thereof, but do not preclude the presence or addition of one or more other features, numbers, operations, members, elements and/or groups thereof.

In addition, in order to help the understanding of the present disclosure, the accompanying drawings are not drawn to scale, but dimensions of some components may be exaggerated. Also, the same reference numerals may be assigned to the same components in different embodiments.

When it is explained that two objects are “identical,” or “the same,” this means that these objects are “substantially identical” or “substantially the same.” In some embodiments, the substantially identical or substantially similar objects may include deviations considered low in the art, for example, deviations within 5%. Also, when it is explained that certain parameters are uniform in a predetermined region, this may mean that the parameters are uniform in terms of an average.

Although the terms first, second, etc. may be used herein to describe various elements, there components should not be limited by these terms. These terms are used only to distinguish one component from another, and unless otherwise stated, it is to be understood that a first component could be termed as a second component.

Throughout the specification, unless otherwise specifically stated, each element may be singular or plural.

When any component is arranged at “an upper portion (or a lower portion)” of the component or “on (or under)” the component, any component may be arranged in contact with an upper surface (or a lower surface) of the component, and another component may be interposed between the component and any component arranged on (or under) the component.

Further, when one component is described as being “connected,” “coupled,” or “connected” to another component, the components can be directly connected or able to be connected to the other component; however, it is also to be understood that an additional component can be “interposed” between the two components, or the two components can be “connected,” “coupled,” or “connected” through an additional component. Also, when a component is referred to as being “electrically connected” to another component, the component may be connected to the other component not only directly but also with one or more intervening components therebetween.

Throughout the disclosure, unless otherwise stated, “A and/or B” means A, B, or A and B. That is, “and/or” includes all or any combination of a plurality of listed items. “C to D” refers to at least C and not more than D, unless otherwise specified.

The terminology used herein is to describe the embodiments of the disclosure and is not intended to limit the disclosure.

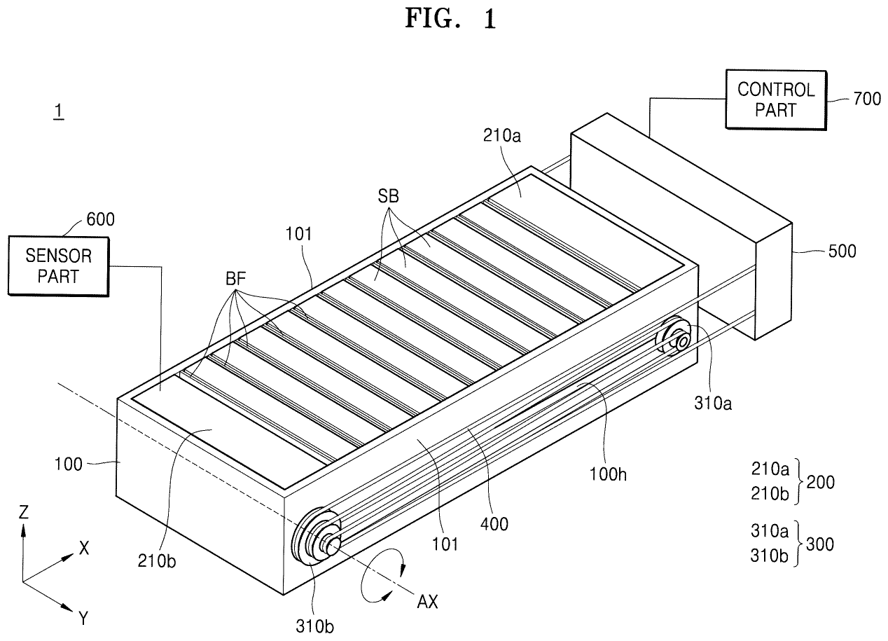

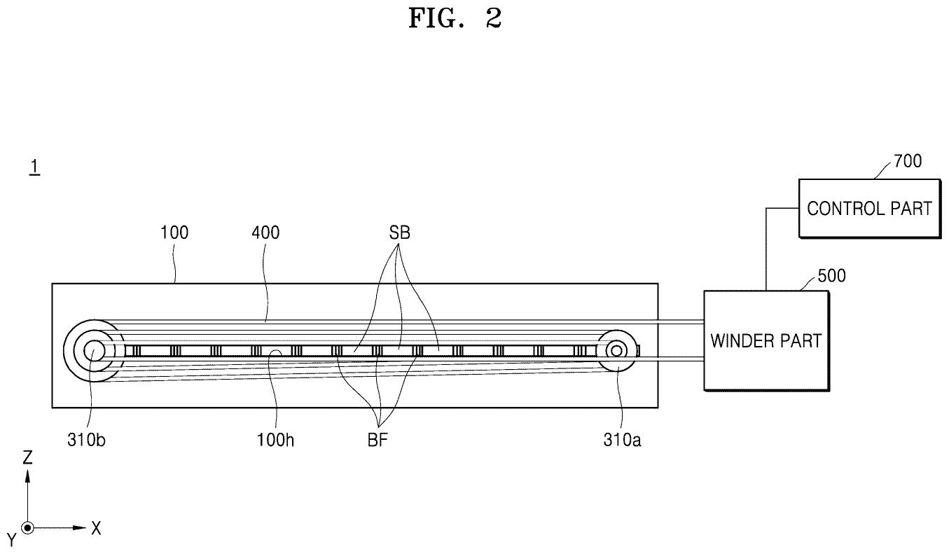

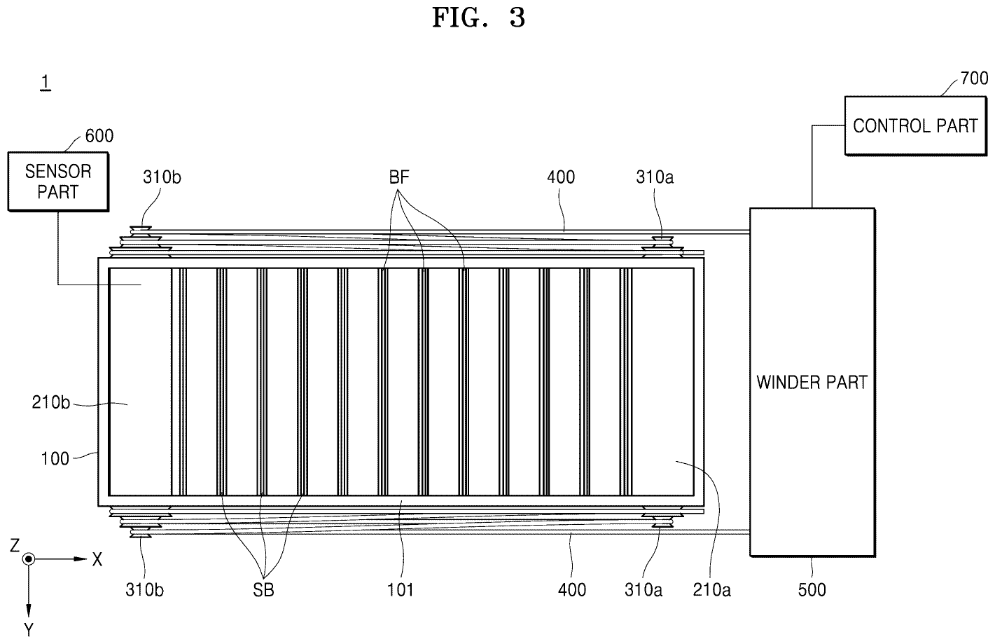

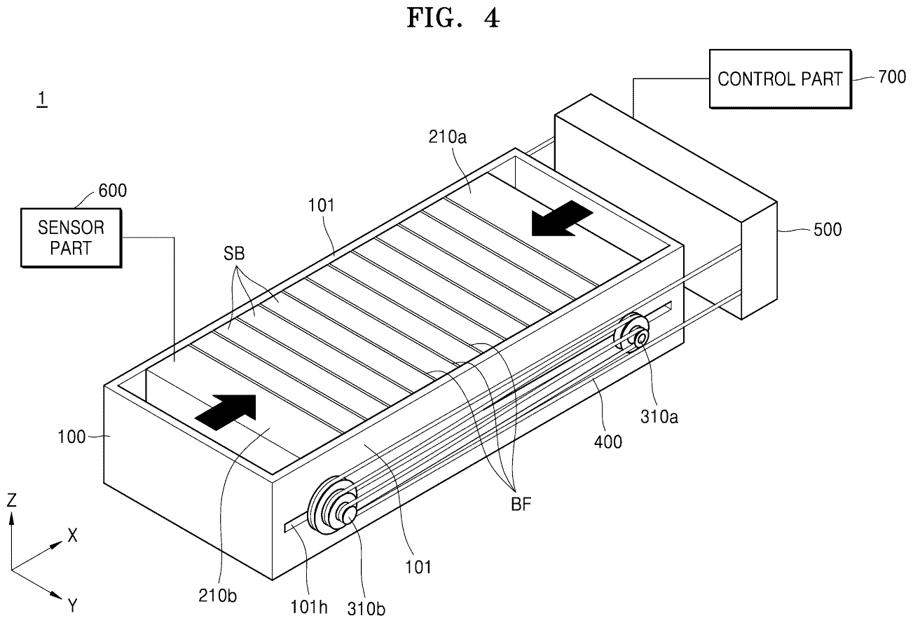

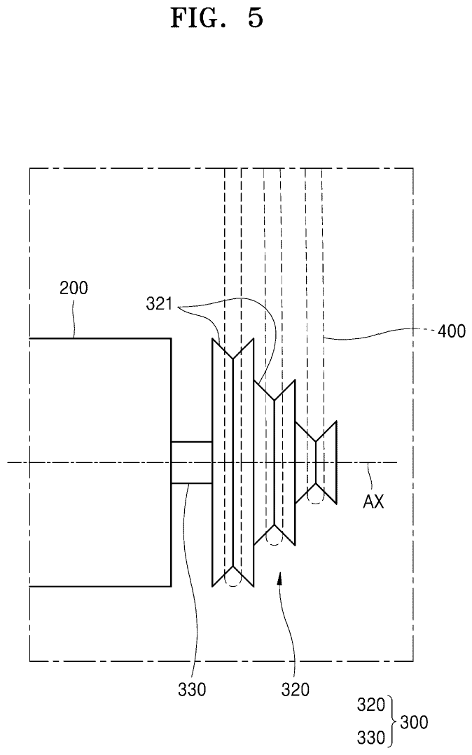

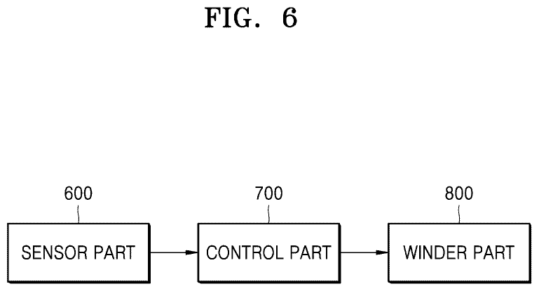

FIG. 1 is a schematic perspective view of a pressing apparatus for a secondary battery according to one exemplary embodiment. FIG. 2 is a side view of the pressing apparatus for the secondary battery illustrated in FIG. 1. FIG. 3 is a top plan view of the pressing apparatus for the secondary battery illustrated in FIG. 1. FIG. 4 depicts the pressing apparatus for the secondary battery illustrated in FIG. 1 applying pressing force to a plurality of secondary batteries. FIG. 5 depicts an end plate and a pulley part according to one exemplary embodiment. FIG. 6 depicts a usage state of a control part according to one exemplary embodiment.

Referring to FIGS. 1 to 3, a pressing apparatus for a secondary battery according to one exemplary embodiment may be configured to press a plurality of secondary battery SB, and may include a case part 100, an end plate 200, a pulley part 300, a wire part 400, a winder part 500, a sensor part 600, and a control part 700.

Referring to FIG. 1, the case part 100 may define a space in which secondary batteries SB may be placed. For example, an opening may be formed through one surface of the case part 100 and the plurality of secondary batteries SB may be inserted into the case part 100 through the opening.

The “secondary battery SB” as used herein may be interpreted as a square secondary battery SB or a pouch-type secondary battery SB.

The case part 100 may be formed in the shape of a rectangular parallelepiped housing. However, it is not limited to this, and the case part 100 may be formed in various shapes that are capable of accommodating or for arranging the secondary batteries SB therein.

The plurality of secondary batteries SB may be arranged inside the case part 100 along a preset one direction.

The “one direction” as used herein may be interpreted as a longitudinal direction of the case part 100 or a longitudinal direction of the wire part 400, and for example, the “one direction” may be interpreted as an X-axis direction based on FIG. 1.

Referring to FIGS. 1 and 3, the plurality of secondary batteries SB and the end plate 200 may be mounted inside the case part 100. The plurality of secondary batteries SB and the end plate 200 may be arranged in the one direction inside the case part 100.

For example, when one end plate 200 is arranged inside the case part 100, the end plate 200 may be arranged on an end portion of the case part 100, and the plurality of secondary batteries SB may be arranged between the end plate 200 and an inner peripheral surface of the case part 100.

In some embodiments, when two end plates 200, namely, a first end plate 210a and a second end plate 210b, are provided inside the case part 100, the first end plate 210a and the second end plate 210b may be respectively arranged on opposite end portions of the case part 100, and the plurality of secondary batteries SB may be arranged (e.g., sequentially arranged) in the one direction between the first end plate 210a and the second end plate 210b.

In some embodiments, the end plate 200 may move inside the case part 100 along the one direction by receiving power from the wire part 400. Responsive to this, the secondary batteries SB may be pressed by receiving pressing force from one surface of the end plate 200 or the inner peripheral surface of the case part 100.

The “end plate 200” as used herein may be interpreted as a term referring to any one end plate 200 of a plurality of end plates 200, and may also be interpreted as a term referring collectively to the first end plate 210a and the second end plate 210b.

Referring to FIGS. 1 and 3, a plurality of buffer members BF may be arranged (e.g., sequentially arranged) inside the case part 100 along the one direction. In some embodiments, the buffer member BF may be arranged between the secondary batteries SB which are adjacent to each other.

The buffer member BF may be made of an elastic material such as rubber. silicone, and/or the like. For example, the buffer member BF may be made of an insulating material.

In some embodiments, even though the secondary batteries SB are pressed by pressure applied from the one surface of the end plate 200 or the inner peripheral surface of the case part 100, damages on the corresponding secondary batteries SB during the pressing process may be alleviated by virtue of the buffer member BF made of the elastic material that is arranged between the secondary batteries SB.

In some embodiments, by arranging the buffer member BF, which is made of the insulating material, between the secondary batteries SB, electrical properties of the secondary batteries SB may be maintained during the pressing process.

A length of an inner space of the case part 100 in a width direction (Y direction based on FIG. 1) may be equal to or relatively longer than a length of the secondary battery SB in the width direction (Y direction based on FIG. 1). This may provide an effect that the secondary battery SB may be stably inserted and placed in the inner space of the case part 100.

Referring to FIGS. 1 and 2, a guide hole 100h extending in the one direction may be formed in a side wall portion 101 of the case part 100, and the pulley part 300 may be connected to a side surface portion of the end plate 200, which is located inside the case part 100, through the guide hole 100h.

The guide hole 100h may be formed in the shape of a hole which penetrates the side wall portion 101 of the case part 100. For example, the guide hole 100h may be formed through one surface of the case part 100 where the pulley part 300 or the wire part 400 is located. The guide hole 100h may extend along the one direction on the one surface of the case part 100 where the pulley part 300 or the wire part 400 is located.

In some embodiments, the pulley part 300 which is connected to the wire part 400 on the outside of the case part 100 may be connected to the end plate 200 through the guide hole 100h, and a movement direction of the pulley part 300 arranged through the guide hole 100h may be guided along an extension direction of the guide hole 100h. This may allow the pulley part 300 to stably move linearly along the one direction, in which the guide hole 100h extends, when the pulley part 300 receives power from the wire part 400.

The winder part 500 may be arranged on one side of the case part 100 to wind or unwind the wire part 400, in response to power being applied from the exterior.

The winder part 500 may be fixedly positioned on the one side of the case part 100. However, it is not limited to this, and the winder part 500 may be spaced apart from the case part 100 at a preset gap.

Referring to FIGS. 1 and 3, the end plate 200 according to one exemplary embodiment which applies pressure to the secondary batteries SB in the one direction may be arranged to be movable inside the case part 100 along the one direction.

In some embodiments, a plurality of end plates 200 may be provided in the case part 100. For example, the plurality of end plates 200 may include a first end plate 210a and a second end plate 210b that are arranged on opposite end portions of the plurality of secondary batteries SB arranged in the one direction.

The plurality of end plates 200 may include a first end plate 210a arranged at one end portion of the case part 100, and a second end plate 210b arranged at another end portion of the case part 100 opposite the one end portion.

The one end portion and another end portion of the case part 100 may be interpreted as one end portion and another end portion of the case part 100 in the one direction, and the winder part 500 may be arranged relatively closer to the one end portion of the case part 100 than to the other end portion of the case part 100.

In one embodiment, the first end plate 210a may be arranged relatively closer to the winder part 500 than the second end plate 210b.

Referring to FIG. 3, the plurality of secondary batteries SB may be arranged in the one direction between the first end plate 210a and the second end plate 210b. In some embodiments, the plurality of buffer members BF may be arranged in the one direction between the first end plate 210a and the second end plate 210b, and the corresponding secondary battery SB may be placed between the buffer members BF adjacent to each other.

Referring to FIGS. 1 and 4, the end plate 200 may be arranged to be movable inside the case part 100 along the one direction, for example, an outer peripheral surface of the end plate 200 may be slidable relative to the inner peripheral surface of the case part 100 in the one direction.

In some embodiments, the side surface portion of the end plate 200 facing the side wall portion 101 of the case part 100 may come into surface-contact with the side wall portion 101 of the case part 100 to be slidable in the one direction.

Referring to FIGS. 3 and 5, the pulley part 300 may be connected to one side of the end plate 200.

For example, the pulley part 300 may be rotatably connected to the side surface portion of the end plate 200 which faces the side wall portion 101 of the case part 100.

Referring to FIG. 3, the pressing apparatus may include a plurality of pulley parts 300. The plurality of pulley parts 300 may be rotatably connected to opposite end portions of the end plate 200 in a longitudinal direction of the end plate 200.

Referring to FIG. 1, the pulley part 300 may be connected to one side of the first end plate 210a. For example, the pulley part 300, e.g., a first pulley 310a may be connected to a side surface portion of the first end plate 210a which faces the side wall portion 101 of the case part 100.

The pulley part 300 may be connected to one side of the second end plate 210b. For example, the pulley part 300, e.g., a second pulley 310b may be connected to a side surface portion of the second end plate 210b which faces the side wall portion 101 of the case part 100. A diameter of the second pulley 310b may be relatively larger than a diameter of the first pulley 310a.

The end plate 200 may be formed in a rectangular parallelepiped shape having a preset thickness in the one direction, but is not limited thereto. The end plate 200 may be formed in various shapes within the technical idea which allows one surface thereof to come into surface-contact with the secondary battery SB and apply pressure to one surface of the secondary battery SB.

Referring to FIGS. 1 to 3 and 5, the pulley part 300 according to one exemplary embodiment, which receives power from the wire part 400 and transmits the received power to the end plate 200, may be connected to one side of the end plate 200.

The pulley part 300 may be rotatably connected to one side of the end plate 200. In some embodiments, the pulley part 300 may be rotatably connected to one surface of the end plate 200 which faces the side wall portion 101 of the case part 100.

A rotational center axis AX of the pulley part 300 may be perpendicular to a center axis of a movement direction of the end plate 200. In some embodiments, the direction of the rotational center axis AX of the pulley part 300 may be a direction perpendicular to the one direction.

Referring to FIG. 2, a diameter of the pulley part 300 located adjacent to the winder part 500 may be relatively larger than a diameter of the pulley part 300 located relatively far (or a distance away or at a greater distance) from the winder part 500.

Referring to FIG. 5, the pulley part 300 may include a pulley body 320 and a connecting portion 330.

The wire part 400 may be wound around an outer circumferential surface of the pulley body 320.

The pulley body 320 may be arranged outside the case part 100, and may be connected to the end plate 200 arranged inside the case part 100 through the connecting portion 330.

A mounting groove 321 may be formed in the outer circumferential surface of the pulley body 320 in a circumferential direction based on the rotational center axis AX of the pulley body 320, and the wire part 400 may be mounted in the mounting groove 321 formed in the outer circumferential surface of the pulley body 320. This may allow the wire part 400 to be firmly connected to the pulley body 320 by being mounted in the mounting groove 321.

Referring to FIG. 5, a plurality of mounting grooves 321 may be sequentially positioned in the outer circumferential surface of the pulley body 320 along the direction of the rotational center axis AX of the pulley part 300.

The plurality of mounting grooves 321 may be configured such that a diameter decreases in a direction away from the end plate 200.

For example, among the plurality of mounting grooves 321, a diameter of a mounting groove 321 adjacent to the end plate 200 may be relatively larger than a diameter of a mounting groove 321 located relatively far (or a distance away or at a greater distance) from the end plate 200.

The connecting portion 330 may be configured to connect the pulley body 320 and the end plate 200. One end of the connecting portion 330 may be connected to the pulley body 320, and another end of the connecting portion 330 opposite to the one end may be connected to the end plate 200.

The one end of the connecting portion 330 may be fixedly connected to the pulley body 320, and the other end of the connecting portion 330 opposite to the one end may be rotatably connected to the end plate 200.

In one embodiment, the one end of the connecting portion 330 may be rotatably connected to the pulley body 320, and the other end of the connecting portion 330 opposite to the one end may be fixedly connected to the end plate 200.

In one embodiment, the one end of the connecting portion 330 may be rotatably connected to the pulley body 320, and the other (a second) end of the connecting portion 330 opposite to the one end may be rotatably connected to the end plate 200.

Referring to FIG. 5, the connecting portion 330 may be arranged on the rotational center axis AX of the pulley part 300. In some embodiments, the connecting portion 330 may be formed in the shape of a shaft extending along the rotational center axis AX of the pulley part 300.

In one embodiment, a longitudinal center axis of the connecting portion 330 may be coaxial with the rotational center axis AX of the pulley part 300.

The connecting portion 330 may be arranged to penetrate the side surface portion of the case part 100. In some embodiments, the connecting portion 330 may be arranged to penetrate the guide hole 100h formed through the side wall portion 101 of the case part 100.

A diameter of the connecting portion 330 may be equal to or relatively smaller than a width of the guide hole 100h. In some embodiments, the connecting portion 330 may be slidable in the one direction along the longitudinal direction of the guide hole 100h while an outer circumferential surface of the connecting portion 330 faces an inner circumferential surface of the guide hole 100h.

Referring to FIGS. 1 to 3, the pulley part 300 may include a first pulley 310a connected to the first end plate 210a and a second pulley 310b connected to the second end plate 210b.

The “pulley part 300” as used herein may be interpreted as a term referring to either the first pulley 310a or the second pulley 310b, but is not limited thereto, and may be interpreted as a term referring collectively to the first pulley 310a and the second pulley 310b.

In one embodiment, a diameter of the first pulley 310a may be smaller or relatively smaller than a diameter of the second pulley 310b.

A diameter of a mounting groove 321 formed in an outer circumferential surface of the first pulley 310a may be relatively smaller than a diameter of a mounting groove 321 formed in an outer circumferential surface of the second pulley 310b.

When the plurality of mounting grooves 321 are formed in each of the outer circumferential surface of the first pulley 310a and the outer circumferential surface of the second pulley 310b, a diameter of a mounting groove 321 which is closest to the first end plate 210a, among the plurality of mounting grooves 321 formed in the outer circumferential surface of the first pulley 310a, may be relatively smaller than a diameter of a mounting groove 321 which is closest to the second end plate 210b, among the plurality of mounting grooves 321 formed in the outer circumferential surface of the second pulley 310b.

In some embodiments, power that is generated in the winder part 500 and transmitted to the wire part 400 may be stably transmitted to the second pulley 310b, which is positioned relatively farther away (or at a greater distance) from the winder part 500 than the first pulley 310a.

Referring to FIGS. 1, 2, and 4, the wire part 400 according to one exemplary embodiment, which transmits power in the one direction to the pulley part 300 so that the end plate 200 moves in the one direction, may be connected to an outer circumferential surface of the pulley part 300.

The wire part 400 may be located on the side wall portion 101 of the case part 100, which faces the side surface portion of the end plate 200, and may extend in the one direction.

The wire part 400 may be connected to the winder part 500. The wire part 400 may receive power from the winder part 500 and transmit the received power to the pulley part 300.

For example, the winder part 500 may receive power applied from the exterior to wind or unwind the wire part 400, the wire part 400 may generate tension by being unwound or wound, and the pulley part 300 may move in the one direction by receiving the tension of the wire part 400. In some embodiments, the end plate 200 connected to the pulley part 300 may apply pressure to the secondary batteries SB while moving inside the case part 100 in the one direction.

The wire part 400 may be arranged to be wound around the first pulley 310a and the second pulley 310b. In some embodiments, the first pulley 310a and the second pulley 310b may be connected to each other by the wire part 400.

The wire part 400 may be wound around the outer circumferential surface of the pulley part 300 while being seated in the mounting groove 321 formed in the outer circumferential surface of the pulley part 300.

In the embodiment where the mounting groove 321 is formed in plurality in the outer circumferential surface of the pulley part 300, the wire part 400 may be wound around the outer circumferential surface of the pulley part 300 a plurality of times by being mounted in each of the plurality of mounting grooves 321.

The wire part 400 may be arranged between opposite end portions of the case part 100. In some embodiments, one side of the wire part 400 may be wound around the first pulley 310a located on one end portion of the case part 100, and another side of the wire part 400 may be wound around the second pulley 310b located on the other (a second) end portion of the case part 100 opposite to the one end portion.

When the pressing apparatus 1 for the secondary battery includes one end plate 200, one side of the wire part 400 may be connected to the end plate 200 arranged at one end portion of the case part 100, and another side of the wire part 400 may be connected to the winder part 500 arranged at the other end portion of the case part 100 opposite to the one end portion.

According to this embodiment, the wire part 400 may be located between the opposite end portions of the case part 100, and thus the end plate 200 and the winder part 500 may be connected to each other by the wire part 400.

In some embodiments, when the winder part 500 winds the wire part 400 to generate tension in the wire part 400, the wire part 400 may transmit the tension to the pulley part 300, which is located at a position opposite to the winder part 500 with respect to the case part 100, and the pulley part 300 which receives the tension may move in the one direction. Responsive to this, the end plate 200 connected to the pulley part 300 may apply pressure to the secondary batteries SB while moving inside the case part 100 in the one direction.

The wire part 400 may be made of a metallic material such as carbon steel wire, stainless steel wire, chrome alloy wire, nickel alloy wire, aluminum alloy wire, titanium alloy wire, and/or the like.

However, it is not limited thereto, and the wire part 400 may be made of a non-metallic material such as nylon, polyester, aramid, high molecular polyethylene, polypropylene, rubber, and/or the like.

Referring to FIGS. 1 to 4, the winder part 500 according to one exemplary embodiment may generate tension in the wire part 400 by receiving power applied from the outside, and may be arranged at one end portion side of the case part 100.

The winder part 500 may be connected to the wire part 400, and the wire part 400 may be wound inside the winder part 500 or unwound to the outside of the winder part 500.

However, embodiments are not not limited thereto, and the winder part 500 may be configured as various devices that are capable of applying tension to the wire part 400 by moving the wire part 400 in a preset direction.

For example, the winder part 500 may be configured as a variety of devices within the technical idea which are capable of applying tension to the wire part 400.

Examples of such devices may include a coil winder, a reel winder, a spool winder, a winch system, a hoist system, a capstan system, a tensioner system, and the like.

Referring to FIG. 4, when the winder part 500 receives power from the outside and winds the wire part 400, a length of the wire part 400 located outside the winder part 500 may gradually decrease. This may result in gradually decreasing a distance between the first pulley 310a and the second pulley 310b connected to the wire part 400.

In some embodiments, a distance between the first end plate 210a connected to the first pulley 310a and the second end plate 210b connected to the second pulley 310b may also gradually decrease, thereby achieving an effect of pressing the secondary batteries SB arranged between the first end plate 210a and the second end plate 210b.

Referring to FIGS. 1 to 4, the winder part 500 may be driven by receiving a control signal from the control part 700.

The control part 700 may receive a command transmitted from a user or a sensor signal transmitted from the sensor part 600. The control part 700 may control the operation of the winder part 500 by detecting pieces of information, such as a position of the end plate 200, strength of pressure that the end plate 200 applies to the secondary batteries SB, a target position of the end plate 200, strength of target pressure that the end plate 200 has to apply to the secondary batteries SB, and/or the like.

Referring to FIGS. 1 to 3, the sensor part 600 according to one exemplary embodiment may be configured to measure information on pressing of the end plate 200 (or pressure applied by the end plate) and may be arranged on one side of the case part 100.

The sensor part 600 may measure at least one sensor information among a position of the end plate 200, tension of the wire part 400, strength of pressure applied by the end plate 200 to the secondary batteries SB, or the number of secondary batteries SB received in the case part 100.

The sensor part 600 may provide the measured sensor information to the control part 700, and the control part 700 may control the operation of the winder part 500 using the provided sensor information.

The sensor part 600 may be connected to one side of the end plate 200, but is not limited thereto, and may be connected to the case part 100 or the winder part 500.

Referring to FIG. 6, the control part 700 according to one exemplary embodiment may control the operation of the winder part 500 by receiving sensor information from the sensor part 600.

The control part 700 may stop the operation of the winder part 500 when it is determined that strength of pressure applied by the end plate 200 to the secondary batteries SB, provided by the sensor part 600, has reached strength of target pressure that the end plate 200 should apply to the secondary batteries SB, which is stored in the control part 700.

The control part 700 may reduce a speed, at which the winder part 500 winds the wire part 400, by controlling the operation of the winder part 500 when strength of pressure applied by the end plate 200 to the secondary batteries SB, provided by the sensor part 600, is larger than a preset value.

The control part 700 may receive information, which relates to strength of pressure applied by the end plate 200 to the secondary batteries SB, from the sensor part 600, to control the operation of the winder part 500 so that the strength of the pressure applied by the end plate 200 to the secondary batteries SB is inversely proportional to the speed at which the winder part 500 winds the wire part 400.

The control part 700 may control the operation of the winder part 500 by using the information, which is provided by the sensor part 600 and relates to the strength of the pressure applied by the end plate 200 to the secondary batteries SB, so that the strength of the pressure applied by the end plate 200 to the secondary batteries SB is inversely proportional to the speed at which the winder part 500 winds the wire part 400.

The control part 700 may receive distance information between the first end plate 210a and the second end plate 210b from the sensor part 600, to control the operation of the winder part 500 so that the distance between the first end plate 210a and the second end plate 210b is proportional to the speed at which the winder part 500 winds the wire part 400.

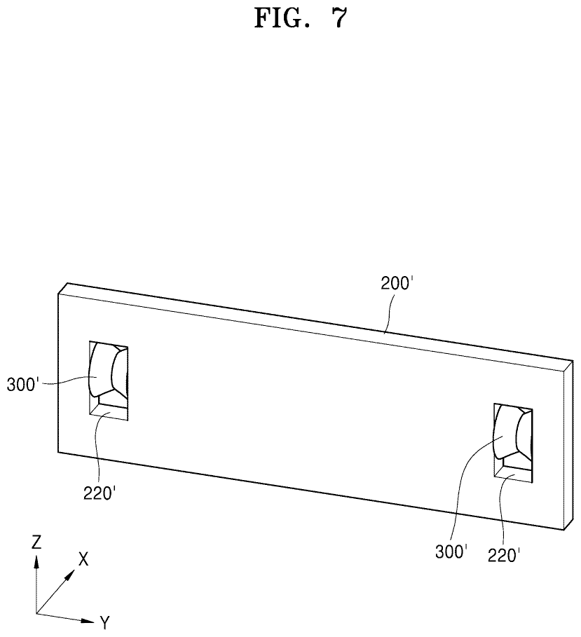

Hereinafter, another pressing apparatus for a secondary battery according to one embodiment of the disclosure will be described with respect to FIG. 7.

The pressing apparatus for a secondary battery according to the embodiment of FIG. 7 has the same configuration, operation principle, and effects as those of the pressing apparatus for the secondary battery according to the embodiment described with respect to FIGS. 1-6, except that in the embodiment of FIG. 7, a support hole 220′ is formed in an end plate 200′ and a pulley part 300′ is arranged inside the support hole 220.′ Therefore, a detailed description of portions of the pressing apparatus already described above with respect to FIGS. 1-6 will be omitted.

FIG. 7 depicts an end plate and a pulley part according to one exemplary embodiment.

Referring to FIG. 7, the support hole 220′ may be formed in the end plate 200′ of a pressing apparatus for a secondary battery according to one exemplary embodiment.

The support hole 220′ may be formed in the shape of a hole penetrating the end plate 200′ in one direction. A plurality of the support holes 220′ may be positioned at opposite end portions of the end plate 200′ in a width direction of the end plate 200′.

The pulley part 300′ may be disposed inside the corresponding support hole 220′ of the end plate 200′ and may be rotatably connected to an inner peripheral surface of the support hole 220′.

In some embodiments, the wire part 400 may be wound around an outer circumferential surface of the pulley part 300′ arranged inside the support hole 220′, thereby reducing the chance of being separated from the pulley part 300′.

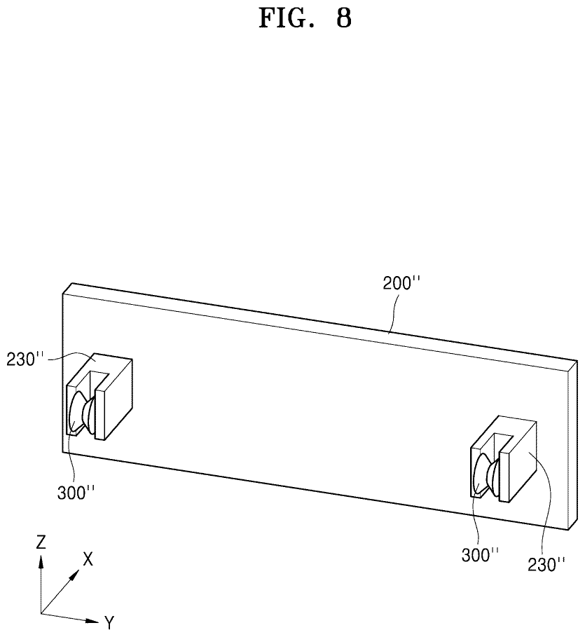

Hereinafter, another pressing apparatus for a secondary battery according to one embodiment will be described with respect to FIG. 8.

The pressing apparatus for a secondary battery according to the embodiment of FIG. 8 has the same configuration, operation principle, and effects as those of the pressing apparatus for the secondary battery according to the embodiment described with respect to FIGS. 1-6, except that in the embodiment of FIG. 8, a support protrusion 230″ is positioned on one side of an end plate 200″ and a pulley part 300″ is connected to the support protrusion 230″. Therefore, a detailed description of portions of the pressing apparatus already described above with respect to FIGS. 1-6 will be omitted.

FIG. 8 depicts yet another end plate and a pulley part according to one exemplary embodiment.

Referring to FIG. 8, the support protrusion 230″ may protrude from the end plate 200″ of a pressing apparatus for a secondary battery according to one exemplary embodiment. In some embodiments, the support protrusion 230″ may be connected to one surface of the end plate 200″ facing the secondary batteries SB.

The support protrusion 230″ may be formed integrally with the end plate 200″, but is not limited thereto, and may be detachably connected to the end plate 200″.

The pulley part 300″ may be rotatably connected to the support protrusion 230″ of the end plate 200″.

In one embodiment, the support protrusion 230″ may be formed in a ‘□’ bracket shape, and the pulley part 300″ may be rotatably connected to an inner peripheral surface of the support protrusion 230″.

Hereinafter, the operation principle and effects of the pressing apparatus for the secondary battery according to one or more embodiments will be explained.

The time-series explanation of the operation principle and method as used herein is for the convenience of explanation, and the operation principle and method described below are not limited to the order of explanation and may be performed in a different order, simultaneously, or concurrently herewith.

According to one embodiment, the pressing apparatus for a secondary battery may include the case part 100 defining a space in which secondary batteries SB are arranged, the end plate 200 arranged inside the case part 100 to apply pressure to the secondary batteries SB, the pulley part 300 connected to the end plate 200 to transmit tension of a wire part 400 to the end plate 200, the wire part 400 wound around the pulley part 300 to apply the tension to the pulley part 300, and the winder part 500 generating the tension in the wire part 400.

A plurality of buffer members BF made of an elastic material may be arranged inside the case part 100 in one direction while being spaced apart at preset gaps.

A user may insert the secondary batteries SB into the case part 100, and for example, place the secondary batteries SB between the buffer members BF.

After placing the secondary batteries SB inside the case part 100, the user may operate the winder part 500. For example, the user may operate the winder part 500 directly or by controlling the operation of the control part connected to the winder part 500.

The wire part 400 may be connected to the winder part 500, and the winder part 500 may receive power from the outside to wind or unwind the wire part 400.

When the wire part 400 is wound by the operation of the winder part 500, the length of the wire part 400 may be gradually shortened, and tension may be generated accordingly. The pulley part 300 connected to the wire part 400 may receive the tension from the wire part 400.

The pulley part 300 may be connected to the end plate 200 through the guide hole 100h formed through the side wall portion 101 of the case part 100, and a movement path of the pulley part 300 may be guided by the guide hole 100h.

The guide hole 100h may extend in one direction on the side wall portion 101 of the case part 100, and thus the movement path of the pulley part 300 may also be guided in the one direction.

When the wire part 400 receives power from the winder part 500 and transmits the power to the pulley part 300, then the pulley part 300 may be guided to move in the one direction through the guide hole 100h, and the end plate 200 connected to the pulley part 300 may also move in the one direction.

Referring to FIG. 4, the first end plate 210a and the second end plate 210b may be arranged inside the case part 100 with the plurality of secondary batteries SB therebetween. When the wire part 400 applies power to a first roller and a second roller in a direction in which the first roller and the second roller come closer to each other, the first end plate 210a and the second end plate 210b may also move in a direction in which they come closer to each other.

Through this, the plurality of secondary batteries SB arranged between the first end plate 210a and the second end plate 210b may be pressed to improve the performance and structural stability of the secondary batteries SB.

In some embodiments, the pressing apparatus 1 for a secondary battery a may include the end plate 200 configured to apply pressure to secondary batteries SB in one direction, and the wire part 400 configured to move the end plate 200, which may improve the structural stability or performance of the secondary batteries SB which receive the pressure from the end plate 200.

According to some embodiments, a pressing apparatus for a secondary battery may include an end plate configured to apply pressure to secondary batteries in one direction, and a wire part configured to move the end plate, which may improve the structural stability or performance of the secondary batteries which receive the pressure from the end plate.

However, aspects and effects obtainable through the various embodiments of the disclosure are not limited to the aspects and effects described above, and other technical aspects and effects not mentioned will be clearly understood by those skilled in the art from the description of the disclosure described below.

Although the disclosure has been described above with reference to some example embodiments and drawings, the disclosure is not limited thereto, and various modifications and variations will be made by those skilled in the art within the scope of the technical idea of the disclosure and the equivalent scope of the patent claims to be described below.

What is claimed is:

1. A pressing apparatus for a secondary battery, the pressing apparatus comprising:
a case part for arranging a plurality of secondary batteries along one direction;
an end plate configured to be movable inside the case part in the one direction, and apply pressure to the secondary batteries in the one direction;
a pulley part connected to one side of the end plate; and
a wire part configured to be wound around the pulley part, and to transmit power in the one direction to the pulley part to move the end plate along the one direction.

2. The pressing apparatus of claim 1, wherein
the pulley part is rotatably connected to the one side of the end plate.

3. The pressing apparatus of claim 2, wherein
a rotational center axis of the pulley part is perpendicular to a center axis of a movement direction of the end plate.

4. The pressing apparatus of claim 1, wherein
the pulley part is connected to a side surface portion of the end plate, and the wire part extends along the one direction on a side wall portion of the case part facing the side surface portion of the end plate.

5. The pressing apparatus of claim 1, wherein
the end plate comprises: a first end plate arranged at one end portion of the case part; and a second end plate arranged at a second end portion of the case part opposite to the one end portion,
the plurality of secondary batteries are arranged between the first end plate and the second end plate along the one direction, and
the pulley part comprises: a first pulley connected to the first end plate; and a second pulley connected to the second end plate.

6. The pressing apparatus of claim 5, wherein
the wire part is wound around each of the first pulley and the second pulley, such that the first pulley and the second pulley are connected to each other.

7. The pressing apparatus of claim 6, further comprising:
a winder part fixedly positioned on the one end portion of the case part and configured to wind or unwind the wire part based on power from outside.

8. The pressing apparatus of claim 7, wherein
a diameter of the first pulley connected to the first end plate adjacent to the winder part is smaller than a diameter of the second pulley connected to the second end plate positioned a distance away from the winder part.

9. The pressing apparatus of claim 4, wherein
a guide hole extending along the one direction is formed in the side wall portion of the case part, and
the pulley part is connected to the side surface portion of the end plate through the guide hole.

10. The pressing apparatus of claim 1, further comprising:
a winder part fixedly positioned on the case part and configured to wind or unwind the wire part based on power from outside.

11. The pressing apparatus of claim 10, wherein
the end plate is arranged at one end portion of the case part, and
the winder part is arranged at a second end portion of the case part opposite to the one end portion.

12. The pressing apparatus of claim 11, wherein
the wire part is arranged between the one end portion and the second end portion of the case part, and connects the end plate and the winder part to each other.

13. A pressing apparatus for a secondary battery, the pressing apparatus comprising:
a case part for arranging a plurality of secondary batteries along one direction;
an end plate configured to be movable inside the case part in the one direction and apply pressure to the secondary batteries in the one direction;
a pulley part connected to one side of the end plate; and
a wire part disposed between opposite end portions of the case part and configured to generate tension in the pulley part.

14. The pressing apparatus of claim 13, wherein
the pulley part is rotatably connected to the end plate.

15. The pressing apparatus of claim 13, wherein
the pulley part is connected to a side surface portion of the end plate, and the wire part extends along the one direction on a side wall portion of the case part facing the side surface portion of the end plate.

16. The pressing apparatus of claim 13, further comprising:
a winder part fixedly positioned on the case part and configured to wind or unwind the wire part based on power from outside.

17. The pressing apparatus of claim 16, wherein
the end plate is arranged at one end portion of the case part, and
the winder part is arranged at a second end portion of the case part opposite to the one end portion.

18. The pressing apparatus of claim 17, wherein
the wire part is arranged between the one end portion and the second end portion of the case part, and connects the end plate and the winder part to each other.

19. The pressing apparatus of claim 16, wherein
the end plate comprises: a first end plate arranged at one end portion of the case part; and a second end plate arranged at a second end portion of the case part opposite to the one end portion,
the plurality of secondary batteries are arranged between the first end plate and the second end plate along the one direction, and
the pulley part comprises: a first pulley connected to the first end plate; and a second pulley connected to the second end plate.

20. The pressing apparatus of claim 19, wherein
a diameter of the first pulley connected to the first end plate adjacent to the winder part is smaller than a diameter of the second pulley connected to the second end plate positioned a distance away from the winder part.
